(19) United States
(12) Patent Application Publication
(10) Pub. No.: US 2020/0258108 A1
(43) Pub. Date: Aug. 13, 2020

(54) Reward Manager

(71) Applicant: Kleberg Bank, Kingsville, TX (US)

(72) Inventors: Cagri Ozen, Austin, TX (US); John Bradley Alan Womack, Kingsville, TX (US); Christopher Michael Medrano, Corpus Christi, TX (US); Dominic Jonah Fischer, Corpus Christi, TX (US)

(73) Assignee: Kleberg Bank, Kingsville, TX (US)

(21) Appl. No.: 16/745,737

(22) Filed: Jan. 17, 2020

Related U.S. Application Data
(60) Provisional application No. 62/793,760, filed on Jan. 17, 2019.

(51) Int. Cl. G06Q 30/02; G06F 16/23; G06F 16/28; G06Q 10/08; G06Q 30/00; G06Q 10/10

(52) U.S. Cl. CPC G06Q 30/0215; G06F 16/2379; G06F 16/284; G06Q 30/0226; G06Q 30/0185; G06Q 30/0224; G06Q 10/10; G06Q 10/087

(57) ABSTRACT

A system and method for processing rewards is provided. A rewards platform comprises a server adapted to managing offers; a plurality of client systems; a network connecting between the server and the plurality of client systems. The server includes a consumer management module, a transaction management module, an offer provider management module, a reward mapping module, and a data access module.

### CROSS-REFERENCE TO RELATED APPLICATION

This application claims the benefit of U.S. Provisional Application No. 62/793,760, filed Jan. 17, 2019; the entirety of which is incorporated herein by reference.

### FIELD

The disclosure relates generally to payment systems. The disclosure relates specifically to methods and systems for processing rewards.

### BACKGROUND

Rewards are various practices, for example, providing discounts, designed to increase sales of a particular produce or services and the profit associated with such sales. Launching reward programs is one of the most effective ways for businesses to raise customer awareness, stimulate more sales, and increase brand loyalty.

The reward delivery mechanism for most loyalty programs has primarily been the use of store coupons, statement inserts, or other printed coupons that require a customer to redeem the coupon in a future purchase. Currently, it is estimated that the percentage of reward coupons that are redeemed by customers is less than 1% of the total coupons distributed. As card-based reward programs and benefits become more widespread, financial institutions and other entities are searching for more cost-effective ways to deliver value to their cardholders.

Kasasa™ checking accounts reward account holders in cash each month for doing banking basics, like paying with a debit card. Each account features a different reward, from cash back to refunds on online purchases. The reward process requires a manual process each month, if the process is not completed or not completed properly, the rewards are not paid.

Jack Henry & Associates, Inc. and Saylent Technologies, Inc. deliver a fully integrated customer rewards solution for Jack Henry & Associates' core clients. The rewards can increase profitability by attracting and retaining customers and deposits by offering high-interest checking, cash-back, and merchandise incentives that reward customers based on their banking relationships and posted account transaction activity during existing statement cycles. But changing of rewards and programs requires the vendor to intervene, testing is difficult, and calculations are compiled monthly.

It is desirable for a reward system to raise customer awareness. However, current rewards systems are too slow to provide rewards. The customers cannot get the incentives in time. It would be advantageous to develop a method and system to calculates rewards daily, thus providing customers near up-to-date monitoring of their incurred rewards.

### SUMMARY

The present invention is directed to a method and system for processing rewards. In one aspect, the invention is directed to a rewards platform, comprises a server adapted to managing offers; a plurality of client systems; a network connecting between the server and the plurality of client systems. The server includes a consumer management module, a transaction management module, an offer provider management module, a reward mapping module and a data access module.

In some embodiments, the rewards platform further comprises a customer database rewards configuration database.

In some embodiments, the consumer management module manages identifying information for each consumer accessing the server; the offer provider management module manages identifying information representing a merchant that accesses the server; the transaction management module monitors or track various product item-level transaction information as the transaction information are received into the server. The reward mapping module matches offers defined or generated by various manufacturers, merchants, retailers with one or more consumers based on previous purchases of items by the customers.

In another aspect, the invention is directed to a rewards method, comprises calculating rewards totals to pay back to customers by mapping a transactional data pulled from a core system to user defined rewards definitions through a relational database structure.

In some embodiments, the method comprises pulling the transactional data from a core system through an SSIS package and placed into a staging table within a local database; taking the user defined rewards definitions and through the relational structure of the database maps the individual transactions to an appropriate reward; calculating the amount of rewards to give back to each eligible account and generates a report of the reward. In some embodiments, the calculating is run daily.

The benefit of the present invention comprises: allowing user visibility intermonth; rewards setup is easily managed by non-technical people and 100% driven without developer input; Intuitive User Interface uses common banking terms to allow operations and sales people to easily develop new rewards; new reward ideas easily can be tested for profitability analysis without affecting live accounts.

The foregoing has outlined rather broadly the features of the present disclosure in order that the detailed description that follows can be better understood. Additional features and advantages of the disclosure will be described hereinafter, which form the subject of the claims.

### BRIEF DESCRIPTION OF THE DRAWINGS

In order that the manner in which the above-recited and other enhancements and objects of the disclosure are obtained, a more particular description of the disclosure briefly described above will be rendered by reference to specific embodiments thereof which are illustrated in the appended drawings. Understanding that these drawings depict only typical embodiments of the disclosure and are therefore not to be considered limiting of its scope, the disclosure will be described with additional specificity and detail through the use of the accompanying drawings in which:

FIG. 1 is a block diagram illustrating a system for processing rewards;

FIG. 2 is a block diagram illustrating a method for processing rewards.

### DETAILED DESCRIPTION

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings making apparent to those skilled in the art how the several forms of the disclosure can be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3^{rd} Edition.

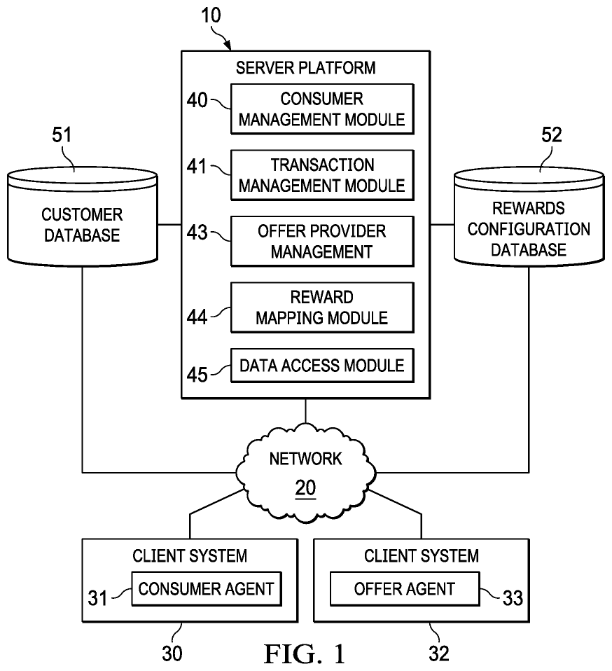

FIG. 1 is a block diagram depicting a system, according to an embodiment, having a client-server architecture configured to perform the various methods described herein. A platform (e.g., including but not limited to machines and software, possibly interoperating via a series of network connections, protocols, and application-level interfaces). In an embodiment, a server platform 10, provides server-side functionality via a communication network 20 to one or more client systems 30, 32, In some embodiments, the network 20 can be a wide area network, local area network, the Internet or other suitable data communications networks. FIG. 1 illustrates, for example, a client system 30 hosting a consumer agent 31, thus allowing a consumer to access those functions of the server platform 10 applicable to the consumer, including, for example, transaction data storage, offer receipt and redemption, and so on. Another client system 32, hosts an offer agent 33 that facilitates use of the server platform 10 applicable to manufacturers, merchants, retailers, and so on, for specifying, tracking, and otherwise managing offers.

In an embodiment, the server platform 10 can be one or more computing devices or systems, storage devices, and other components that include, or facilitate the operation of, various execution modules depicted in FIG. 1. These modules can include, for example, a consumer management module 40, a transaction management module 41, an offer provider management module 43, a reward mapping module 44, and a data access module 45. In some embodiments, the computer system can include a Web server that is able to host a Web site thereon and a number of Web based applications associated with the Web site, such as a user profile generator. In these embodiments, the clients can access the server simply by connecting to the Internet and opening the appropriate URL address of the Web site. The server platform 10 can include an interface/API module 48, which can provide a web interface, an API, or another type of interface facilitating access by the client systems 30, 32 to the various modules of the server platform 10.

The server platform 10 has access to or is otherwise able to query a customer database 51 containing various type of information of customers and rewards configuration database 52 containing various type of rewards information. The customer database 51 carries information about the customer, the information can include demographic characteristics such as age, gender, marital status, and education level of the customer. The information can also include a traveler's contact information, credit card information, and transaction record. The rewards configuration database 52 carries information about reward scheme provided by manufacturers, merchants or retailers. Wherein a reward scheme consists of the details of the reward and criteria for offering the reward to a customer. The information can include discount on a product or service, loyalty points, freebies, product warranties, tie-in promotions, cross selling, up selling, and premiums. The data access module 45 can facilitate access to databases 51 and 52 by any of the modules of the server platform 10.

Although the databases 51 and 52 are shown to reside externally to the platform 10, those of ordinary skill in the art will understand that the databases can also be integrated into the server platform 10.

The consumer management module 40 can manage identifying information for each consumer accessing the server platform 10. The identified information can include names, passwords, contact information, and additional information pertaining to the consumers. In some examples, this additional information can include user preference information, demographic information, previous purchase information, and other data related to the particular user. In one embodiment, the information associated with each consumer can be stored or retrieved from the customer database 51. The offer provider management module 43 can manage identifying information representing a manufacturer, merchant, retailer, or similar entity that accesses the server platform 10. The identified information can include names, passwords, contact information, and other information pertaining to the manufacturer or other entity. The offer provider management module 43 can also receive parameters regarding one or more offers on products or services devised by manufacturers, retailers, and other entities. In an example, such parameters can include the type of offer (e.g., including but not limited to a discount on a product or service, loyalty points, freebies, product warranties, tie-in promotions, cross selling, up selling, and premiums). The products to be purchased and any customer attributes that would trigger the delivery of an offer to a consumer, the terms of the reward or incentive resulting from triggering the offer, any expiration date or time associated with the offer, and so on. The user of the offer client system 32 can devise such offers, modify the offers in response to interim results regarding the offer, and engage in related activities via the offer provider management module 43. In one implementation, the information associated with each offer can be stored to and retrieved from the rewards configuration database 52.

The transaction management module 41 can monitor or track the various product item-level transaction information as they are received into the server platform 10. The transaction information can be received from a number of sources, such as paper receipts held by the consumer; electronic transaction data provided by a merchant, a payment service provider, and a third-party aggregator. The transaction information can include, but not limited to, the name of the product, the product ID, unit price and quantity of the product, the name of the provider, the Customer name, transaction Card ID. In one embodiment, the information associated with each transaction can be stored or retrieved from the customer database 51.

In one embodiment, the transaction information can be in the form of paper receipts provided by one or more retailers that list individual items or services purchased by the consumer. In one example, the consumer operating the consumer client system 30 can scan and/or photograph a paper receipt, the resulting image of which is then processed to generate data identifying the various items purchased. In other examples, the consumer client system 30 can receive an electronic receipt or similar data from a retailer. Such information can be received as information displayed on a webpage to the consumer, as text provided in an e-mail message, or other communication and/or electronic record transmitted to the consumer. In one embodiment, the transaction is made via a website, a browser application executing on the consumer client system 30 can record purchases made by the consumer via the consumer client system 30. The transaction data can be sent to the transaction management module 41via the communication network 20 and stored into the customer database 51.

The reward mapping module 44 can match offers defined or generated by the various manufacturers, merchants, retailers, or other entities with one or more consumers based on previous purchases of items by the customers, as set forth by the parameters defining the offers. The reward mapping module 44 can also consider other factors in matching offers to consumers, such as the demographic details of the consumers, their user preferences, locations where they have shopped previously, and other information associated with the consumers.

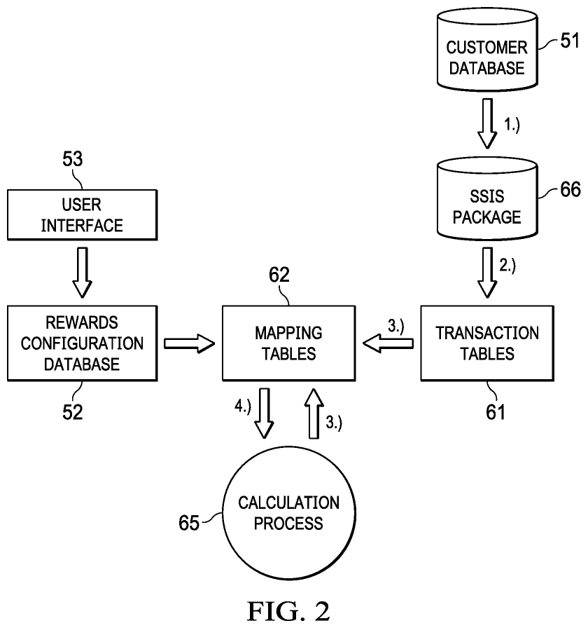

In operation, a manufacturer, retailer, or other commercial entity can communicate with the offer provider management module 43 via the client system 32 and the user interface 53, to specify and/or modify purchase offers for products or services. FIG. 2. The resulting offer data are stored in the rewards configuration database 52. The reward mapping module 44 can then access portions of the offer data from the rewards configuration database 52, transaction data from the customer database 51, to match current offers with one or more consumers represented in the customer database 51. The rewards platform calculates rewards totals to pay back to customers by mapping transactional data pulled from a core system to user defined rewards definitions through a relational database structure.

The transactional data is pulled from a core system (for example, the customer database 51) through an SSIS package 66 and placed into a staging table within a local database. The relational database is a collection of data items organized as a set of tables with each table organized into columns and rows. For example, a staging transaction table 61 for a customer in a specific date extracted from the customer database 51 is shown as Table 1.

TABLE 1

| Customer | Customer- | Card | Product | Product | Unit | | | Provider | |
|---|---|---|---|---|---|---|---|---|---|
| name | ID | ID | name | ID | price | Quantity | Provider | ID | Date |
| Pat | 12 | 25 | Apple | 23 | $1.39 | 2 | Walmart | 46 | Jan. 2, 2018 |
| Ken | 12 | 23 | cinema | 1 | $6.99 | 3 | AMD | 21 | Jan. 2, 2018 |
| | | | ticket | | | | | | |
| Mary | 12 | 25 | Tomato | 5 | $2.49 | 3 | Costco | 14 | Jan. 2, 2018 |
| Chris | 12 | 23 | Orange | 6 | $1.49 | 6 | Costco | 14 | Jan. 2, 2018 |

Then, an offer data in a specific date is extracted from the rewards configuration database 52 which is shown as Table 2.

TABLE 2

| Product | Product | Unit | | Provide | | Provider | |
|---|---|---|---|---|---|---|---|
| name | ID | price | Quantity | offer | Provider | ID | Date |
| apple | 23 | $1.39 | 2 | Null | Walmart | 46 | Jan. 2, 2018 |
| cinema | 1 | $10.99 | 3 | Refunds | AMD | 21 | Jan. 2, 2018 |
| ticket | | | | $2 | | | |
| tomato | 5 | $2.49 | 3 | 20% | Costco | 14 | Jan. 2, 2018 |
| | | | | discount | | | |
| orange | 6 | $1.49 | 6 | 10% | Costco | 14 | Jan. 2, 2018 |
| | | | | discount | | | |

A calculation process 65 is run that takes the user defined rewards definitions and through the relational structure of the database maps the individual transactions to the appropriate reward.

Next, these mappings are consumed in a calculation process that tallies up the amount of rewards to give back to each eligible account and generates a report of the rewards breakdown to form a mapping table 62. Table 3 shows the result of rewards to give back to each eligible account.

TABLE 3

| Customer | Card | Product | Product | Unit | | | Provide | | |
|---|---|---|---|---|---|---|---|---|---|
| name | ID | name | ID | price | Quantity | Provider | offer | Refunds | Date |
| Ken | 23 | cinema | 1 | $6.99 | 3 | AMD | Refunds $2 | $6 | Jan. 2, 2018 |
| | | ticket | | | | | | | |
| Mary | 25 | tomato | 5 | $2.49 | 3 | Costco | 20% discount | $1.494 | Jan. 2, 2018 |
| Chris | 23 | orange | 6 | $1.49 | 6 | Costco | 10% discount | $0.894 | Jan. 2, 2018 |

This calculation process is ran daily, thus providing customers near up-to-date monitoring of their incurred rewards.

All of the compositions and methods disclosed and claimed herein can be made and executed without undue experimentation in light of the present disclosure. While the compositions and methods of this disclosure have been described in terms of preferred embodiments, it will be apparent to those of skill in the art that variations can be applied to the compositions and methods and in the steps or in the sequence of steps of the methods described herein without departing from the concept, spirit and scope of the disclosure. More specifically, it will be apparent that certain options which are related can be substituted for the options described herein while the same or similar results would be achieved. All such similar substitutes and modifications apparent to those skilled in the art are deemed to be within the spirit, scope and concept of the disclosure as defined by the appended claims.

What is claimed is:

1. A rewards platform, comprising
a server adapted to managing offers;
a plurality of client systems;
a network connecting between the server and the plurality of client systems;
wherein the server includes a consumer management module, a transaction management module, an offer provider management module, a reward mapping module and a data access module.

2. The rewards platform of claim 1, further comprising a customer database rewards configuration database.

3. The rewards platform of claim 1, wherein the consumer management module manages identifying information for each consumer accessing the server.

4. The rewards platform of claim 1, wherein the offer provider management module manages identifying information representing a merchant that accesses the server.

5. The rewards platform of claim 1, wherein the transaction management module monitors or track various product item-level transaction information as the transaction information are received into the server.

6. The rewards platform of claim 1, wherein the reward mapping module matches offers defined or generated by various manufacturers, merchants, retailers with one or more consumers based on previous purchases of items by the customers.

7. A rewards method, comprising calculating rewards totals to pay back to customers by mapping a transactional data pulled from a core system to user defined rewards definitions through a relational database structure.

8. The rewards method of claim 7, comprising
pulling the transactional data from a core system through an SSIS package and placed into a staging table within a local database.
taking the user defined rewards definitions and through the relational structure of the database maps the individual transactions to an appropriate reward;
calculating the amount of rewards to give back to each eligible account and generates a report of the reward.

9. The rewards method of claim 7, wherein the calculating is performed daily.
